(19) United States
(12) Patent Application Publication
(10) Pub. No.: US 2026/0367646 A1
(43) Pub. Date: Nov. 19, 2026

(54) SYSTEM FOR MANAGING THE EMERGENCY LANDING TRAJECTORY OF A DRONE OR UNMANNED AIRCRAFT

(71) Applicant: THALES, MEUDON (FR)

(72) Inventors: François NEFFLIER, TOULOUSE (FR); Martin BOULANGER, TOULOUSE (FR); Christian ARNAUDO, TOULOUSE (FR)

(21) Appl. No.: 19/132,274

(22) PCT Filed: Oct. 30, 2023
(86) PCT No.: PCT/EP2023/080185

§ 371 Date: May 22, 2025

(30) Foreign Application Priority Data
Nov. 24, 2022 (FR) FR2212254

(51) Int. Cl. G05D 1/654; G05D 1/229; G05D 109/20; G08G 5/54; G08G 5/57; G08G 5/58; G08G 5/59

(52) U.S. Cl. CPC G05D 1/6546; G05D 1/2295; G08G 5/54; G08G 5/57; G08G 5/58; G08G 5/59; G05D 2109/20

(57) ABSTRACT

A system for managing the emergency landing trajectory of a drone, includes: a ground control station including a first computer equipped with a determination module for continuously determining a first emergency landing trajectory and a checking module for checking the first trajectory; and a control unit on-board the drone including a second computer, including a determination module for continuously determining a second landing trajectory, a detection module for detecting a critical hazard involving a switch from a nominal mode to an emergency landing mode activating the operation of a selection module to select the first or second emergency landing trajectory; the selection module being configured to select the first devised emergency landing trajectory or the second emergency landing trajectory in such a way as to select the first trajectory if the first trajectory takes into account the current value of the operational or environmental parameter(s) of the drone representing the detected critical hazard, and to select the second trajectory if the first trajectory takes into account a last received value differing from the current value of the operational or environmental parameter(s) of the drone representing the detected critical hazard.

The present invention relates to a system for managing the emergency landing trajectory of a drone or unmanned aircraft.

The invention relates to unmanned aircraft or drones. The invention relates to the determination of an emergency landing solution in the event of a critical hazard requiring a rapid landing in a zone that does not result in human losses. Hazards can be caused by weather, a failure of an on-board system, or a loss of localization.

The object of the invention is to solve the problem of taking a decision to interrupt a mission far away from the operator who does not have a correct reconstruction of the environment, particularly in the event of delays in the transmission of information from the drone, due to its remoteness or even a loss of transmission.

The operator of the unmanned aircraft or drone has hitherto been responsible for detecting that a hazard no longer allows the mission to continue. Based on his perception of a critical hazard, his role consists in using simple macro commands such as “return to base” or “land the drone where it is located”, for example by means of a spiral descent to the ground.

These solutions work well when the drone is moving at a short distance from the operator and the operator has a good knowledge of the environment of the drone. This is not the case with missions lasting several hours. The systems must then provide automatic solutions for the operator.

Long-range drone operations, or, in other words, flight missions of more than 10 km, must provide a solution to the various critical hazards such as:
a critical level of energy autonomy: energy monitoring detects that the drone no longer has the capacity to reach the nearest predetermined landing zone;
flight performance degradation due to an actuator failure, excessive wind, or a structural problem resulting from impact with an external element, where tracking the position of the drone in relation to the trajectory detects that the guidance and autopilot functions no longer allow the trajectory to be followed; or
a critical divergence of the position in the event of a loss of the GNSS position, for which tracking is put in place and, beyond a certain period of time, growing uncertainty no longer ensures the navigability of the drone.

In these cases, an emergency mode is defined so that the drone responds to the critical hazard.

In the case of long-range operations, the conventional flight termination system (FTS), which consists in triggering the opening of a parachute or carrying out a spiral descent, is not viable because it is difficult for the operator to get an accurate picture of the situation, as the drone is several tens or even hundreds of kilometers from the operator.

Existing solutions for finding a path between two points while avoiding obstacles use path-finding algorithms. However, in the case of drones, the low-cost, on-board hardware solution does not provide the necessary performance for such algorithms.

Moreover, development costs for drones must be the lowest for reasons of competitiveness. For reasons of development costs relating to the level of certification and performance, the path-finding solution cannot be chosen.

One object of the invention is to respond to the above-mentioned problems, focusing on the emergency landing trajectory calculated by the drone system (ground/on-board) in the event of a critical hazard requiring the aircraft to land as quickly as possible, said trajectory having to bring the aircraft to a zone without human activity while guaranteeing observance of no-fly zones, taking into account the terrain, and taking into account the presence of obstacles such as prohibited zones.

According to one aspect of the invention, a system is proposed for managing an emergency landing trajectory of a drone, comprising:
a ground control station comprising a first computer equipped with:
   a determination module for continuously determining a first emergency landing trajectory taking into account the last value of at least one parameter representing the operation or the environment of the drone, said value being received from the drone, and an emergency landing database, configured to calculate the first emergency landing trajectory from a path search algorithm, from the emergency landing database, and from the last received value of the operational or environmental parameter(s) of the drone; and
   a verification module to verify the first trajectory, from the emergency landing database; and
a control unit on-board the drone, comprising a second computer, comprising:
   a determination module for continuously determining a second emergency landing trajectory from the emergency landing database and from the current value of at least one operational or environmental parameter of the drone, configured to calculate the second emergency landing trajectory by including, for each emergency landing point, a lateral trajectory calculation, a vertical trajectory calculation, and configured to check that the emergency trajectory is secured in a safety corridor, from the emergency landing database, and from the last value of the operational or environmental parameter(s) of the drone;
   a detection module for detecting a critical hazard involving a switch to an emergency landing mode activating the function of a selection module for selecting the first or the second emergency landing trajectory, a hazard having been detected from the current value of at least one operational or environmental parameter of the drone; and
   the selection module being configured to select the first devised emergency landing trajectory or the second emergency landing trajectory in such a way as to select the first trajectory if the first trajectory takes into account the current value of the operational or environmental parameter(s) of the drone representing the detected critical hazard, and to select the second trajectory if the first trajectory takes into account a last received value differing from the current value of the operational or environmental parameter(s) of the drone representing the detected critical hazard.

In one embodiment, the landing database includes polygonal landing zones, no-fly zones, and obstacles.

According to one embodiment, the landing database includes landing points with an associated final approach axis and an associated altitude, no-fly zones, and obstacles.

In one embodiment, the determination module for continuously determining a second emergency landing trajectory is configured to calculate emergency landing points by defining a landing point search area, identifying the segments of the polygons directly visible in a straight line, and, for each landing point:
determining a final approach axis for each landing point; and
checking adherence to a safety corridor of the trajectory avoiding no-fly zones and obstacles.

According to one embodiment, the determination module for continuously determining a second emergency landing trajectory is configured to evaluate the landing points, from the nearest to the farthest, by calculating a lateral trajectory, an emergency landing vertical trajectory, and an associated safety corridor.

In one embodiment, the second computer has less computing power than the first computer.

The invention will be better understood by studying some embodiments described as non-limiting examples and illustrated by the attached drawings, in which:

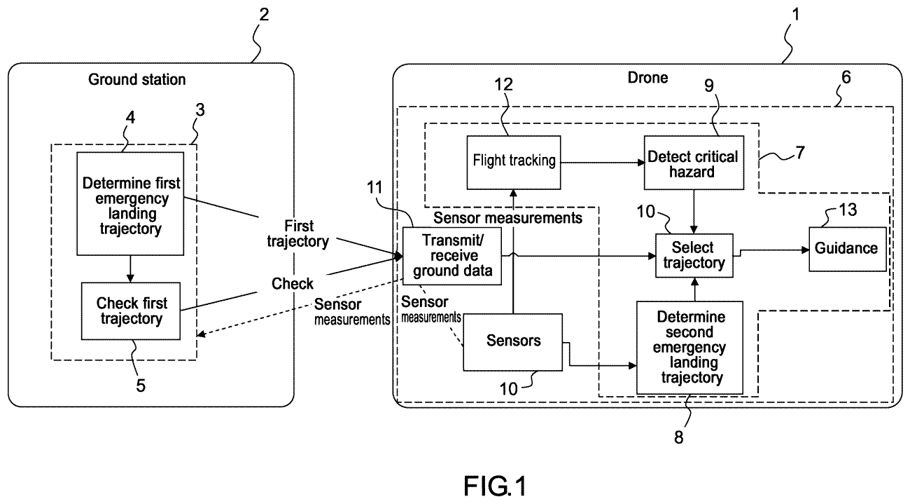

FIG. 1 illustrates schematically a system for managing an emergency landing trajectory of a drone, according to one aspect of the invention; and

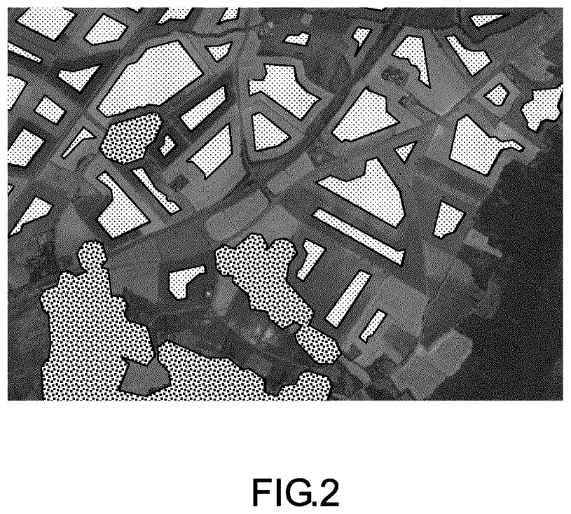

FIG. 2 illustrates schematically an emergency landing database, according to one aspect of the invention;

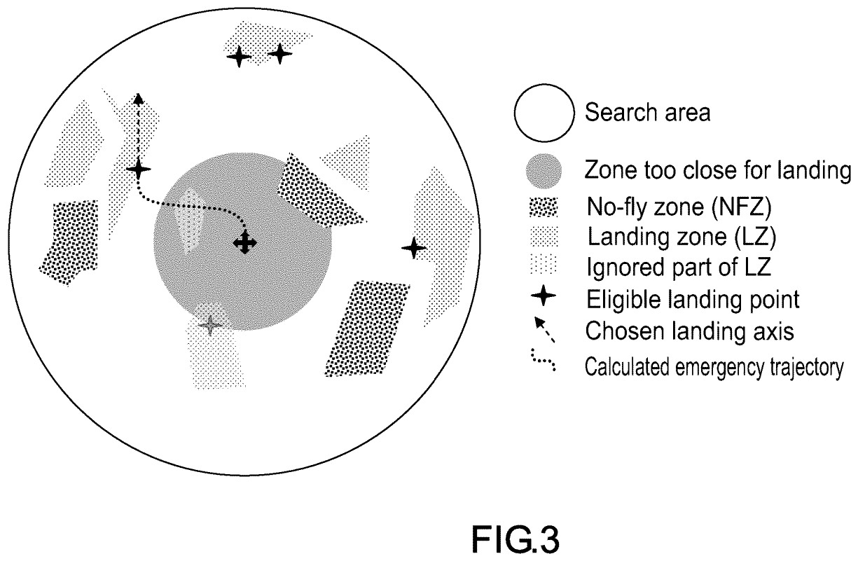

FIG. 3 illustrates schematically the identification on-board the drone of the landing zones of a database of an emergency landing database, according to one aspect of the invention;

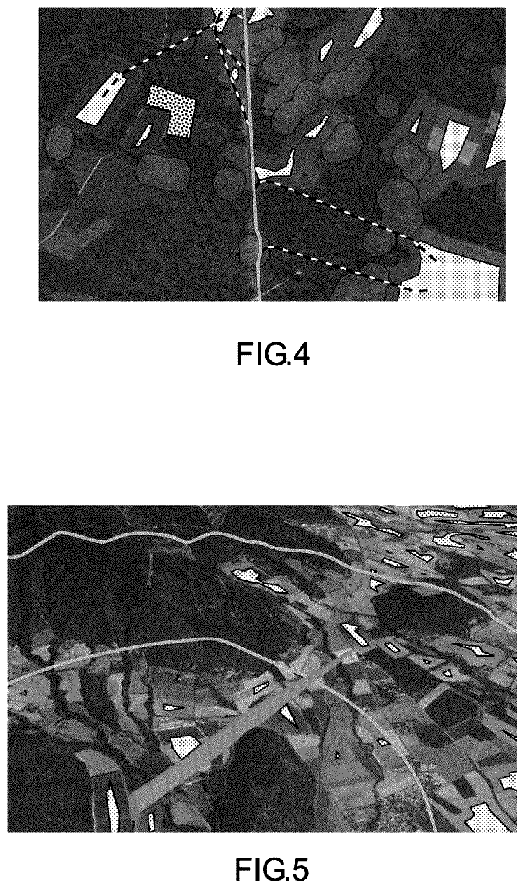

FIG. 4 illustrates schematically an evaluation on-board the drone of the eligible landing points, along a lateral trajectory, according to one aspect of the invention; and

FIG. 5 illustrates schematically an evaluation on-board the drone of the changes in an eligible landing point, along a vertical trajectory, according to one aspect of the invention.

Elements having identical references are similar in all of the figures.

FIG. 1 illustrates schematically a system for managing an emergency landing trajectory of a drone 1, according to one aspect of the invention. The system comprises a ground control station 2 comprising a first computer 3 equipped with:
a determination module 4 for continuously determining a first emergency landing trajectory taking into account the last value of at least one parameter representing the operation or the environment of the drone, said value being received from the drone, and an emergency landing database; and
a checking module 5 for checking the first trajectory, from the emergency landing database.

The sensors 14 of the drone 1 provide measurements to a transceiver module 11 of the drone 1 which transmits them to the first computer 3 of the ground control station 2. The sensors 14 of the drone 1 also provide these measurements to a flight-tracking module 12 tracking the flight of the drone 1 and allowing, from these measurements of the sensors 14, the determination of hazards, such as an inability to fly to the end of the mission with the remaining energy capacities, an overshooting of deviations lateral and vertical to the trajectory compared with predefined thresholds, or equipment failures.

The system also comprises a control unit 6 on-board the drone comprising a second computer 7 having, for example, a lower computing power than the first computer 3, which comprises:
a determination module 8 for continuously determining a second emergency landing trajectory from the emergency landing database and from the current value of at least one operational or environmental parameter of the drone;
a detection module 9 for detecting a critical hazard involving a switch to an emergency landing mode activating the operation of a selection module 10 to select the first or second emergency landing trajectory, a hazard being detected from the current value of at least one operational or environmental parameter of the drone; and
the selection module 10 being configured to select the first devised emergency landing trajectory or the second emergency landing trajectory in such a way as to select the first trajectory if the first trajectory takes into account the current value of the operational or environmental parameter(s) of the drone representing the detected critical hazard, and to select the second trajectory if the first trajectory takes into account a last received value differing from the current value of the operational or environmental parameter(s) of the drone representing the detected critical hazard.

The determination module 4 for continuously determining a first emergency landing trajectory is configured to calculate the first emergency landing trajectory from a path search algorithm, from the emergency landing database, and from the last received value of the operational or environmental parameter(s) of the drone.

The determination module 8 for continuously determining a second emergency landing trajectory is configured to calculate the second emergency landing trajectory by including, for each emergency landing point, a lateral trajectory calculation and a vertical trajectory calculation, and is configured to check that the emergency trajectory is secured in a safety corridor, from the emergency landing database, and from the last value of the operational or environmental parameter(s) of the drone.

The landing database comprises polygonal landing zones LZ, and no-fly zones NFZ.

The landing database comprises landing points with an associated final approach axis and an associated altitude, and no-fly zones.

The determination module 8 for continuously determining a second emergency landing trajectory is configured to calculate emergency landing points by defining a landing point search area, and, for each landing point:
identifying the segments of the polygons that are directly visible in a straight line;
determining a final approach axis for each landing point; and
checking adherence to a safety corridor of the trajectory avoiding no-fly zones.

The determination module 8 for continuously determining a second emergency landing trajectory is configured to evaluate the landing points, from the nearest to the farthest, by calculating an emergency landing lateral trajectory and vertical trajectory.

The basic idea of the present invention is to use two separate emergency trajectory calculation algorithms on the two computers: to have a simple trajectory calculation on-board the drone and a more elaborate solution in the ground control station.

An on-board trajectory selection algorithm allows the system to switch to emergency mode to select the emergency trajectory to be flown. The selected trajectory is then sent to the guidance/control module 13 for execution.

The determination module 8 of the second computer 7 on-board calculates a second basic “direct-to” trajectory, between the drone and a landing zone. The determination module 4 of the first computer 3, in the ground control station 2, calculates a second, more complex, trajectory before it is returned to the drone.

The selection module 10 is configured to select the first devised emergency landing trajectory or the second emergency landing trajectory in such a way as to select the first trajectory if the first trajectory takes into account the current value of the operational or environmental parameter(s) of the drone representing a detected critical hazard, and to select the second trajectory if the first trajectory takes into account a last received value differing from the current value of the operational or environmental parameter(s) of the drone representing the detected critical hazard.

The flight-tracking module 12 of the drone 1 detects the inability to fly to the end of the mission with the remaining energy capacities, the overshooting of lateral and vertical deviations compared with predefined thresholds, and equipment failures. The result of this tracking is transmitted to the critical hazard detection module 9 which, in the event of detection of a critical hazard that no longer allows the mission to continue and requires an emergency landing (for example within two or three minutes), switches to an emergency landing mode. The ground operator also has the ability to trigger an emergency landing if he considers the situation to require it.

The present invention enables:
the provision of a reasonable computational load in the drone using low-capacity hardware;
a reasonable certification cost;
algorithm simulation on the ground during mission preparation in order to validate landing solutions throughout the mission; and
elimination of the need for storage on-board the drone of a set of emergency solutions calculated on the ground to respond to a critical hazard in the event of loss of communication.

On detection of a critical hazard involving a switch to an emergency landing mode, the selection module 10 selects the first devised emergency landing trajectory or the second emergency landing trajectory in such a way as to select the first trajectory if the first trajectory takes into account the current value of the operational or environmental parameter(s) of the drone representing the detected critical hazard, and selects the second trajectory if the first trajectory takes into account a last received value differing from the current value of the operational or environmental parameter(s) of the drone representing the detected critical hazard.

Thus, on-board the drone, in the switch to emergency landing mode, there is potentially a choice between two solutions: the one from the ground and the one calculated on board. The selection function determines which of these two solutions is the most relevant.

A data set defining the reasons for the emergency switch is associated with each emergency trajectory: low battery, loss of position, loss of equipment, etc. These data may have had an impact on the calculated emergency solution.

For example, constraints relating to remaining autonomy can reduce the landing point search area.

The selection mechanism of the module 10 operates as follows:
if the data sets associated with the first and second emergency trajectories are consistent:
   this means that the ground control station 2 is well aware of the current constraints detected on-board the drone 1;
   priority is given to the first trajectory provided by the ground control station 2, determined using more complex algorithms.
Otherwise:
   the information in the ground control station 2 does not match the information on-board the drone 1, due to a transmission problem;
   the critical hazard detected on-board the drone 1 is considered more relevant; and
   the trajectory calculated on board is chosen.

Ahead of the mission, the emergency landing database is created on the ground and loaded on board the aircraft at the start of the mission. FIG. 2 shows an example of a map representing an emergency landing database.

These landing zones LZ correspond to zones identified as safe, and are modelled by polygons. These polygons are generated using a plurality of data sources.

On the landing zones, a safety margin is subtracted, corresponding to the distance required for the drone to descend without touching an obstacle that would be at the edge of the landing zone, and taking into account an uncertainty (inaccuracy of terrain elevation, inaccuracy of altitude measurement, etc.). This safety margin depends on the type of drone (technical characteristics) and its capabilities (gradient of descent). Thus, any point in a landing zone is a valid landing point.

The emergency landing database also includes no-fly zones.

Alternatively, the landing database can include landing points with an associated final approach axis and an associated altitude.

The determination module 8 for continuously determining the second emergency landing trajectory from the emergency landing database and from the current value of at least one operational or environmental parameter of the drone 1.

The determination module 8 for continuously determining the second emergency landing trajectory, on-board the drone 1, comprises the major steps of:
determining eligible landing points, if necessary, i.e. if the landing database does not already contain them;
for each landing point:
   calculating the lateral trajectory;
   calculating the vertical trajectory; and
   checking that the trajectory is secure (defining a safety corridor and
checking that it does not coincide with a no-fly zone or with an obstacle).

If the landing database does not directly contain landing points, but landing zones, the eligible landing points are determined as follows by the module 8, as shown in FIG. 3.

A search area is determined in which a landing point is sought.

This area is defined by an arc of a circle, or a circle, centered on the position of the drone, extrapolated to X seconds before (X being the frequency of calculation of this emergency solution of the second computer 7) and the current heading of the drone 1. The length of the area corresponds to the maximum distance travelled by the drone in an emergency: for example two or three minutes in this case.

The angle of the search area can be set according to the performance of the drone or various external constraints.

The polygons in the landing database previously loaded on-board the drone 1 are then evaluated in relation to this search area. Only the polygon segments included in the search area are considered. They are limited to the boundaries of the search area if necessary.

A polar co-ordinate projection is performed so that it is easy to determine which zones are directly visible in a straight line from the center of the search area, in which angular sector and at what distance.

The visible landing zones are then identified. The projections identify the angular sectors that allow a landing zone LZ to be reached, and the distance involved. The fact that the edges of the landing zones (polygons) take into account a safety margin ensures that any point in the landing zone is an eligible landing point.

This will determine a set of eligible landing points to evaluate—for example, by aiming at the center of the segments of the visible landing zones LZ.

It may be necessary to determine a particular landing axis to improve landing safety depending on the type of drone 1 or flight conditions (such as wind).

In this case, from an eligible landing point, it is possible to repeat a projection within the landing zone in order to determine a landing axis (or several landing axes) leaving sufficient distance to land within the zone.

It is possible to include consideration of other parameters such as wind direction.

Each landing point, with its associated final approach axis and its associated altitude, must then be evaluated for the two cases of the landing, landing zone or landing point database.

A plurality of evaluation strategies are possible, for example, from the nearest to the farthest, or from the nearest from the minimum distance to land to the farthest.

Each landing point evaluation carries out the following steps.

First, a lateral trajectory is calculated, as shown in FIG. 4. The lateral trajectory calculation looks for the most direct joining trajectory from a given position and heading, to arrive at a given point with a given heading.

The starting point of the algorithm is the center of the search area, and the current heading of the drone 1. The end point corresponds to the start point of the approach. It is positioned along the landing axis, before the landing point. The (straight) approach segment is then added at the end of the trajectory.

A vertical trajectory is then calculated, as shown in 3D in FIG. 5, which takes into account the terrain elevations available in a terrain database on-board the drone 1, and the characteristics of the drone 1.

The trajectory must also adhere to the terrain-tracking constraints to ensure that it remains flyable without risking a collision with the terrain. If this is not possible, the landing point is rejected or ignored.

Finally, the trajectory is checked to ensure that it does not coincide with prohibited zones or obstacles (integrated as prohibited zones into the database). For this purpose, a safety corridor around the trajectory is taken into account. If this is not possible, this landing point is ignored.

As soon as an eligible landing point has allowed the calculation of a safe trajectory, the calculation can stop: a valid solution has been found.

All these calculations are performed continuously on-board the drone 1 with a certain calculation frequency, limited by the capabilities of the second computer 7. A landing solution is thus updated regularly from the measured context.

If an emergency trajectory is selected by the selection module 10 in order to be flown, new emergency trajectories are constantly recalculated in order to propose an adequate solution to changes in the critical hazards on-board the drone 1.

The determination module 4 for continuously determining a first emergency landing trajectory first constructs a path that takes into account no-fly zones NFZ. The computing capacity of the first computer 3 of the ground station 2 is generally greater than on-board the drone 1 in the second computer 7, and allows the ground to use path-finding algorithms (Theta* or Field D*) or RRT (rapid-scan random tree) algorithms.

This path is then provided to a trajectory calculation algorithm in order to calculate the first 3D landing trajectory to take into account the terrain. The first trajectory is then provided to the first-trajectory verification module 5. Its role is to ensure that a trajectory is flyable by proposing a design assurance level (DAL), equal to the algorithms installed on-board the drone 1. The algorithm serves to verify that the trajectory is flyable in terms of continuity and performance, that there is no conflict with the terrain, obstacles and no-fly zones. The result of the check and the trajectory are transmitted to the drone 1.

The trajectory thus produced is sent on-board the drone, periodically or intermittently, in order to be taken into account in the event of critical hazards requiring the switch to emergency mode.

The present invention thus ensures that an emergency landing trajectory is always available throughout the mission, which responds to the nature of the critical hazard encountered.

Dynamic calculation of a trajectory that takes into account the current context of the drone 1 avoids the pre-loading of a substantial number of solutions on-board. This reduces the memory capacity that needs to be allocated to trajectory storage.

The solution continues to operate even if communication between the ground station 2 and the drone 1 is lost.

The use of a simple algorithm on-board the drone 1 enables high-speed simulation of the course of the flight in preparation for the mission in order to identify sections not covered by an emergency solution.

1. A system for managing the emergency landing trajectory of a drone, comprising:
a ground control station comprising a first computer equipped with:
a determination module for continuously determining a first emergency landing trajectory taking into account the last value of at least one parameter representing the operation or the environment of the drone, said value being received from the drone, and an emergency landing database, configured to calculate the first emergency landing trajectory from a path search algorithm, from the emergency landing database, and from the last received value of the operational or environmental parameter(s) of the drone; and
a verification module to verify the first trajectory, from the emergency landing database; and
a control unit on-board the drone, comprising a second computer, comprising:
a determination module for continuously determining a second emergency landing trajectory from the emergency landing database and from the current value of at least one operational or environmental parameter of the drone, configured to calculate the second emergency landing trajectory by including, for each emergency landing point, a lateral trajectory calculation, a vertical trajectory calculation, and configured to check that the emergency trajectory is secured in a safety corridor, from the emergency landing database, and from the last value of the operational or environmental parameter(s) of the drone;
a detection module for detecting a critical hazard involving a switch to an emergency landing mode activating the function of a selection module for selecting the first or the second emergency landing trajectory, a hazard having been detected from the current value of at least one operational or environmental parameter of the drone; and
the selection module being configured to select the first devised emergency landing trajectory or the second emergency landing trajectory in such a way as to select the first trajectory if the first trajectory takes into account the current value of the operational or environmental parameter(s) of the drone representing the detected critical hazard, and to select the second trajectory if the first trajectory takes into account a last received value differing from the current value of the operational or environmental parameter(s) of the drone representing the detected critical hazard.

2. The system as claimed in claim 1, wherein the landing database comprises polygonal landing zones (LZ), no-fly zones (NFZ), and obstacles.

3. The system as claimed in claim 1, wherein the landing database comprises landing points with an associated final approach axis and an associated altitude, no-fly zones, and obstacles.

4. The system as claimed in claim 2, wherein the determination module for continuously determining a second emergency landing trajectory is configured to calculate emergency landing points by defining a landing point search area, by identifying the segments of the polygons directly visible in a straight line, and, for each landing point:
determining a final approach axis for each landing point; and
checking adherence to a safety corridor of the trajectory avoiding no-fly zones and obstacles.

5. The system as claimed in claim 3, wherein the determination module for continuously determining a second emergency landing trajectory is configured to evaluate the landing points, from the nearest to the farthest, by calculating a lateral trajectory, an emergency landing vertical trajectory, and an associated safety corridor.

6. The system as claimed in claim 1, wherein the second computer has less computing power than the first computer.
